(19) United States
(12) Patent Application Publication
(10) Pub. No.: US 2009/0094792 A1
(43) Pub. Date: Apr. 16, 2009

(54) SLIDING SCREEN DOOR MECHANISM

(76) Inventor: Sam L. Blais, Muskegon, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 12/118,069

(22) Filed: May 9, 2008

Related U.S. Application Data
(63) Continuation of application No. 11/673,027, filed on Feb. 9, 2007, now abandoned.
Application No. 11/673,027 is a continuation of application No. 11/860,917, filed on Sep. 25, 2007, now abandoned.

(51) Int. Cl. E05D 15/06

(52) U.S. Cl. 16/96 R

(57) ABSTRACT

A sliding screen door mechanism (100) includes a bottom channel (122), top channel (124) and side channel (126). The bottom channel (122) has a web (132) and a bottom mount (134) which is screw fastened to a surface surrounding an entry door (112). The top channel (124) includes a top web (152), top door track (156) and top mount (154).

### CROSS-REFERENCE TO RELATED APPLICATIONS

This application is a continuation of co-pending U.S. patent application Ser. No. 11/860,971, filed Sep. 25, 2007, which is a continuation of U.S. patent application Ser. No. 11/673,027, filed Feb. 9, 2007.

### STATEMENT REGARDING FEDERALLY SPONSORED RESEARCH OR DEVELOPMENT

Not Applicable.

### REFERENCE TO SEQUENCE LISTING

Not Applicable.

### BACKGROUND OF THE INVENTION

The invention relates to screen door mechanisms generally and more particularly to sliding screen door mechanisms.

### BRIEF SUMMARY OF THE INVENTION

Accordingly, a sliding screen door mechanism of the invention has a screen door, a top channel slidably engaging a top of the screen door, and a bottom channel slidably engaging a bottom of the screen door. The bottom channel is an elongated that has opposing first and second ends, a length that extends to the second end from the first end, and a bottom web that extends along the length. The bottom web has opposite first and second edges, and the bottom channel also has a bottom mount at the first edge. A bottom door track extends along the second edge. The top channel is an elongated member that is spaced above and aligned with the bottom channel. The top channel has opposite first and second ends, has a length that extends to the second end from the first end, and has a top web that extends along the length. The top web has opposite first and second edges, and the top channel also has a top mount at the first edge. A top door track extends along the second edge.

In other aspects of the invention, a side channel extends between the respective top and the bottom channel first ends. A top stop is located at the top channel second end, while a bottom stop is located at the bottom channel second end.

### BRIEF DESCRIPTION OF THE SEVERAL VIEWS OF THE DRAWING

FIG. 1 is a front end perspective view of a sliding screen door mechanism of the invention;

FIG. 2 is a front elevation thereof,

FIG. 3 an exploded end perspective view of a bottom channel thereof, showing a bottom door stop;

FIG. 4 is an end perspective view of a top channel of the mechanism, showing a top door stop;

FIG. 5 is an end perspective view of a side channel of the mechanism;

FIG. 6 is a fragmented perspective view of the bottom channel installed at a door threshold;

FIG. 7 is an end perspective view of the top channel; and

FIG. 8 is an end perspective view of the bottom channel of the mechanism;

### DETAILED DESCRIPTION

A preferred embodiment of a sliding screen door mechanism 100 according to the invention is generally shown in the drawing figures and discussed below. The exemplary mechanism 100 generally includes a substantially conventional screen door 110 and a slide frame.

The slide frame is adapted to at least partially circumscribe an entry door 112 and includes a bottom channel 122, a top channel 124, and a side channel 126. As shown, the bottom channel 122 may be an elongated and generally Z-shaped member with a bottom web 132 that extends along a length of the channel. The bottom web 132 has two opposite edges. A bottom mount 134 is provided at one of the bottom web edges. A door track 136 is provided at the other web edge. The bottom channel 122 may be constructed of any suitable structural material and by any process that is suitable to the selected material. An aluminum alloy extrusion is anticipated as a common fabrication, for example.

The bottom mount 134 is adapted to mount the bottom channel 122 on a generally vertical surface as is typically known to surround an entry door 112. More specifically as shown, the bottom mount 134 may be a flange portion and may further be adapted with spaced apertures 142 to screw fasten the bottom channel to the surface surrounding the door. Although, one having ordinary skill in the art realizes that alternative fastenings may be used.

The bottom door track 136 may be a flange portion as shown, that is adapted to cooperate with the door 110 in sliding engagement. More specifically, the door has a bottom edge 114 that may be provided with grooved wheels that are adapted to receive and roll along a rail, including track 136, as is known by one having ordinary skill in the art.

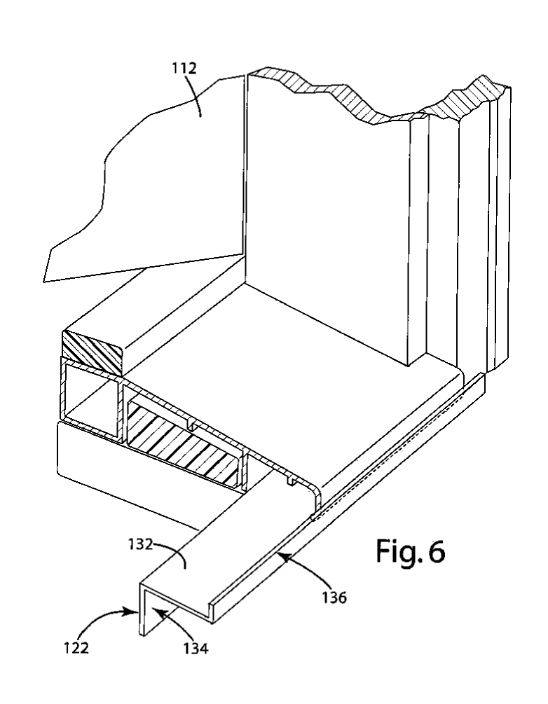

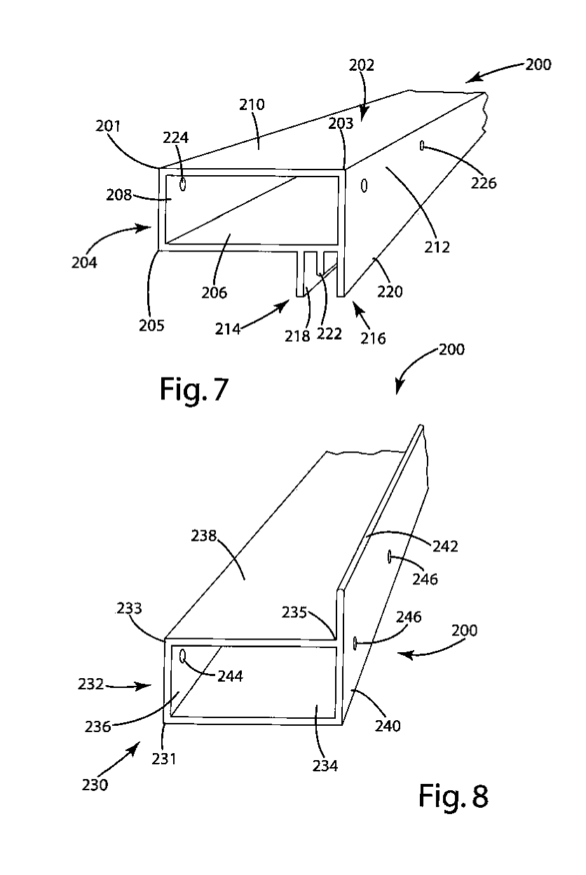

As disclosed in FIG. 6, trim moldings, including so called “brick molding” trims that are used around doors, are typically of a uniform thickness. Thus, a door threshold may extend outward a standard distance from the surface that surrounds the door. For this reason, the web 132 of the bottom channel 122 may have a width that centers the bottom door track about 1⅝ inch (41.3 mm) away from the vertical surface or wall, which surrounds the entry door. Similarly, door thresholds are of standardized dimension, so the bottom door track 136 may typically extend about one inch (25.4 mm) above the web 132. The bottom channel mount 134 may extend about one inch (25.4 mm) down from the web.

The length of the bottom channel 122, and also the top channel 124, is dictated by the width of the door 112 and its associated trim. The sliding screen door 110 will preferably have a width that is wide enough for the screen door to overlay and cover the entry door 112 and its side trims. In order for the screen door to slide clear of the entry door, then, the lengths of the bottom and the top tracks will need to be at least twice the width of the screen door. An additional margin of length of about a half inch (12.7 mm) should be added to the top and the bottom channels to allow for the top channel stop, which is discussed further below.

Similar to the bottom channel 122, the top channel 124 may be an elongated member with a top web 152 that extends along a length of the channel. The top web has two opposite edges. A top mount 154 is provided at one of the top web edges. A top door track 156 is provided at the other top web edge. The top channel 124 may be also be constructed of any suitable structural material and by any process that is suitable to the selected material. An aluminum alloy extrusion is anticipated as a common fabrication for the top channel 124 as well as the bottom channel 122.

The top door track 156 includes a pair of flanges 158 as with shown, that are adapted to cooperate with the door 110 in sliding engagement. More specifically, the flanges provide a downward opening U-channel portion that is adapted to receive a top of the door in sliding engagement as is known by one having ordinary skill in the art. The flanges extend down about two inches (50.8 mm) from the web 152. A spacing of the flanges 158 to define a clear space of about ⅝ inch (15.9 mm) between the flanges is expected to be common, although this specific dimension is not critical to the invention and the spacing of the flanges 158 in a given installation will be determined by screen door 110 used and more particularly by the thickness of the top of the door.

It is noted that the U-channel of the top door track 156 is relatively deep to accommodate convenient installation and subsequent re-seating of the door 110. The screen door may be slid into and onto the top and the bottom door tracks, respectively, from an end of the tracks, if sufficient room is provided in a particular installation and the door stops, discussed below, are removed or otherwise not installed. More conveniently, and requiring no space at an end of the slide frame, the screen door 110 is conveniently seated and installed at any point along the top 124 and the bottom 122 channels. The top of the screen door 110 may be inserted into the top door track 156 sufficiently far so that the bottom of the door 110 may be located above and aligned with the bottom door track 136. The screen door may then be lowered on to the bottom door track. This maneuvering of the screen door to seat the bottom of the door onto the bottom door track 136 with the top of the door captured in the top door track is allowed by the depth of the U-channel of the top door track. The depth of the top door track may be said to accommodate “over insertion” of the screen door into the top door track.

The top mount 154 is adapted to mount the top channel 124 on the generally vertical surface that surrounds the entry door 112, similar to the discussion above relative to the bottom channel. Thus, the top mount 154 may further include a flange portion and be adapted with spaced apertures 144 to screw fasten the bottom channel to the surface surrounding the door. The top channel mount 154 may extend about one inch (25.4 mm) up from the web. As noted above, alternative fastenings may be used.

Again, the bottom channel 122 extends, and the bottom door track 136 is thereby spaced, from the vertical surface or wall, which surrounds the entry door 112 basically because of the extensions of each of the entry door trim molding and its threshold. Thus, the top channel 124 also extends from the vertical surface. While the bottom door track 136 may be centered about 1⅝ inch (41.3 mm) away from the wall as discussed above, the top door track may also be centered about 1⅝ inch (41.3 mm) away from the wall to align the bottom and the top door tracks, which orients the screen door 110 generally parallel with the entry door 112 and with the surrounding wall into which the entry door is installed.

The side channel may also be an elongated member with a side web 162 that extends along a length of the side channel and a side flange 166 that extends along at least a portion of the side channel length. The side web has two opposite edges with the side flange provided at one of the side web edges. Again, as with the bottom and the top channels, the side channel 126 may be constructed of any suitable structural material and by any process that is suitable to the selected material, and an aluminum alloy extrusion is anticipated as a common fabrication.

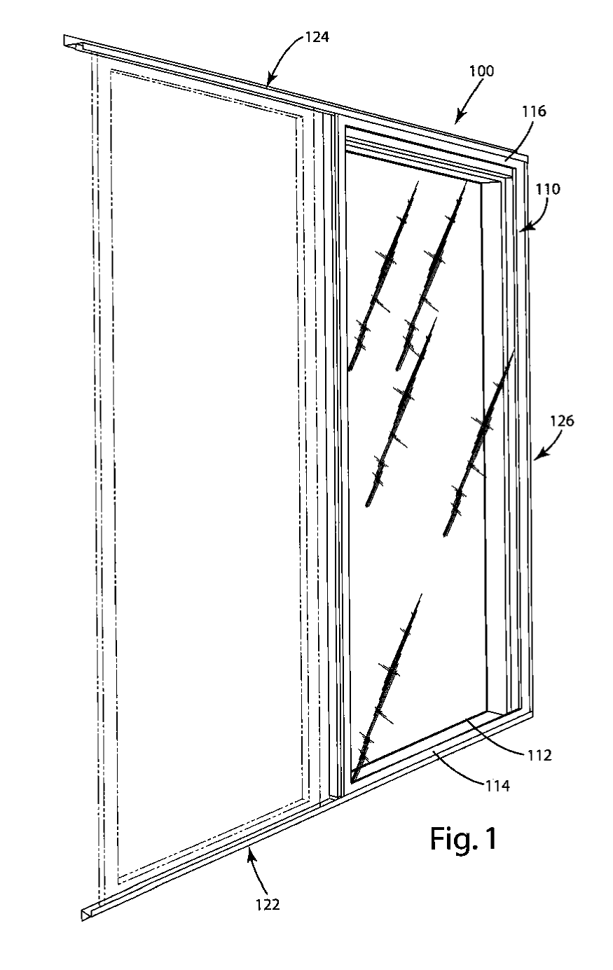

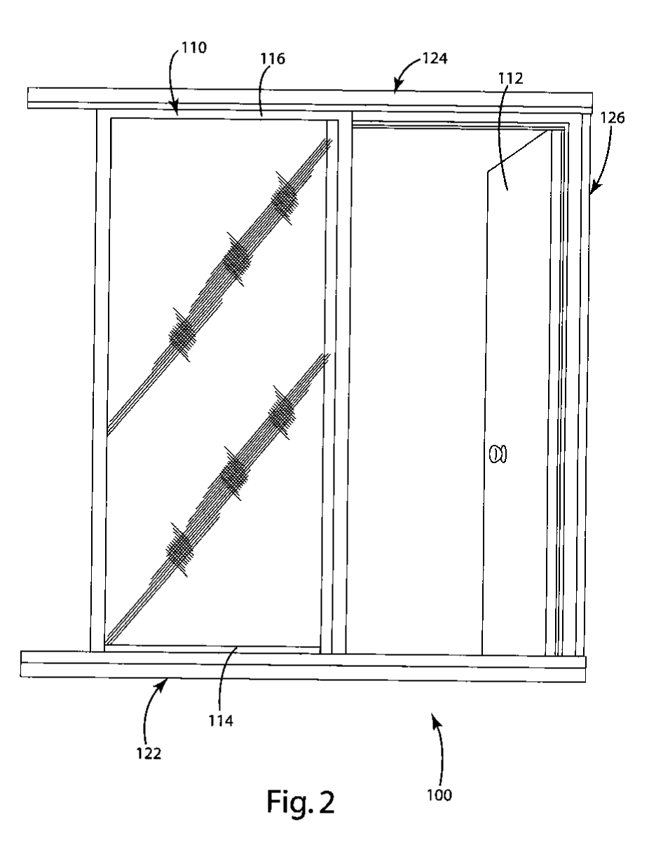

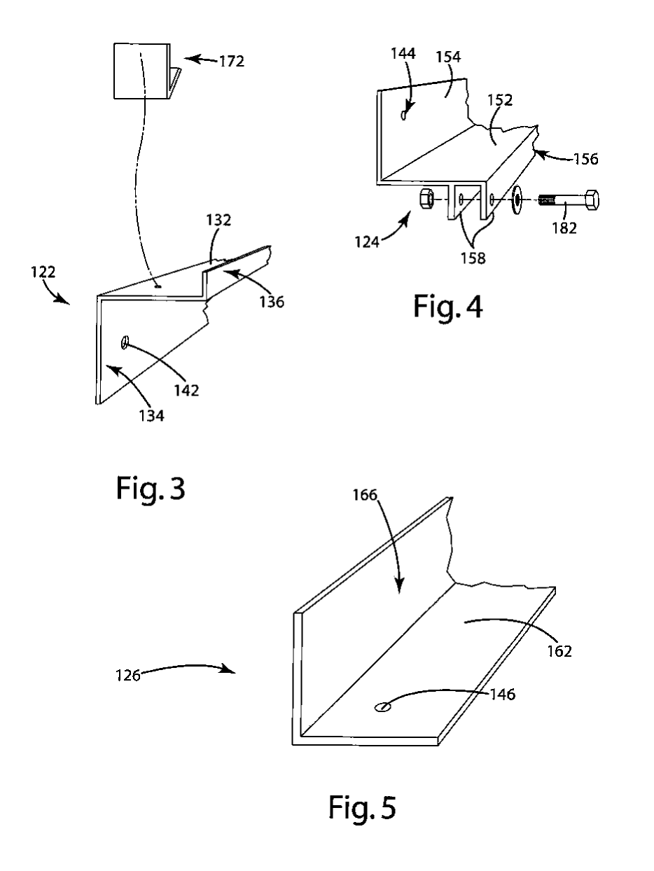

The side channel web 162 is the side channel mount and may have a width of about 1 to 1⅛ inch (25.4-28.6 mm) with apertures 146 for screw mounting as discussed above relative to each of the bottom and the top channels. The side flange 166 provides a strike or stop for the sliding screen door 110 in a closed position (FIG. 1), and also provides a latch mounting jamb. While the side channel 126 may extend between respective first ends of the bottom and the top channels, 122 and 124 respectively, and a screen door jamb at the entry door 112, separate stops may be provided at respective opposite second ends of the bottom and the top channels.

More specifically, a bottom channel stop 172 may include a block or an L-bracket as shown. The bottom stop is located and mounted at the second end of the bottom channel 122. Further, the bottom stop 172 blocks the screen door 110 from sliding off the second end of the bottom channel. A top stop 182 may also be provided at the second end of the top channel 124. The top stop may be conveniently constructed with a screw or a bolt and the like that is mounted through the U-channel of the top door track 156 near the top channel end. Thus, the top stop 182 blocks the screen door 110 from sliding off the second end of the top channel 124. While one or the other of the bottom and the top stops, 172 and 182 respectively, may be used individually, they may also be used together. The top and the bottom stops are preferably aligned with one another when both the bottom and the top stops are used.

One having ordinary skill in the art and those who practice the invention will understand from this disclosure that various modifications and improvements may be made without departing from the spirit of the disclosed inventive concept. One will also understand that various relational terms, including left, right, front, back, top, and bottom, for example, are used in the detailed description of the invention and in the claims only to convey relative positioning of various elements of the claimed invention.

What is claimed is:

1. A sliding screen door mechanism comprising:
an elongated bottom channel that has opposing first and second ends, a length that extends to the second end from the first end, and a bottom web that extends along the length, the web having opposite first and second edges, the bottom channel also having a bottom mount at the first edge and having a bottom door track extending along the length at the second edge;
an elongated top channel that is spaced above and aligned with the bottom channel, that has opposing first and second ends, that has a length that extends to the second end from the first end, and that has a top web that extends along the length, the web having opposite first and second edges, the top channel also having a top mount at the first edge and having a top door track extending along the length at the second edge;
a side channel that extends perpendicularly between the respective top and the bottom channel first ends;
a top stop at the top channel second end;
a bottom stop at the bottom channel second end; and
a screen door extending between and slidably engaging each of the bottom and the top channels.

2. A sliding screen door mechanism comprising:
an elongated bottom channel that has opposing first and second ends, a length that extends to the second end from the first end, and a bottom web that extends along the length, the web having opposite first and second edges, the bottom channel also having a bottom mount at the first edge and having a bottom door track extending along the length at the second edge;
a side channel that extends perpendicularly from the bottom channel first end to a terminal end;
an elongated top channel that is spaced above the bottom channel, that extends perpendicularly from the side channel terminal end, that has opposing first and second ends, that has a length that extends to the second end from the first end, and that has a top web that extends along the length, the web having opposite first and second edges, the top channel also having a top mount at the first edge and having a top door track extending along the length at the second edge;
a top stop at the top channel second end; and
a bottom stop at the bottom channel second end.
